(19) United States
(12) Patent Application Publication
(10) Pub. No.: US 2026/0117749 A1
(43) Pub. Date: Apr. 30, 2026

(54) DRIVETRAIN OF WIND TURBINE WITH LUBRICATION SYSTEM AND WIND TURBINE COMPRISING LUBRICATION SYSTEM

(71) Applicant: Envision Energy Co., Ltd., WUXI (CN)

(72) Inventors: Stephan Uhkoetter, Dortmund (DE); Ralf Rueschoff, Dortmund (DE); Matthias Walkowiak, Dortmund (DE); Uemit Mermertas, Dortmund (DE)

(73) Assignee: Envision Energy Co., Ltd., WUXI (CN)

(21) Appl. No.: 19/433,223

(22) Filed: Dec. 26, 2025

Related U.S. Application Data
(63) Continuation of application No. PCT/CN2023/113039, filed on Aug. 15, 2023.

(51) Int. Cl. F03D 80/70; F01M 1/10; F03D 9/25

(52) U.S. Cl. CPC F03D 80/707; F01M 1/10; F03D 9/25; F01M 2001/1057; F05B 2260/4031; F05B 2260/98

(57) ABSTRACT

The present invention relates to a drivetrain of a wind turbine and a wind turbine with the drivetrain, wherein the drivetrain comprises at least a gearbox, a generator and a lubrication system. The lubrication system comprises at least a pump unit, a main filter system, a heat exchanger and a distribution unit. A secondary filter system is arranged upstream relative to the distribution unit and downstream relative to the heat exchanger. The first filter system has at least one first filter with a first filtration range and the secondary filter system has at least one second filter with a second filtration range. The first filtration range differs from the second filtration range.

### CROSS-REFERENCE TO RELATED APPLICATIONS

This application is a continuation of International Application No. PCT/CN2023/113039, filed on August 15, 2023, titled “A drivetrain of a wind turbine with a lubrication system and a wind turbine comprising the lubrication system”, the entire contents of which are incorporated herein by reference.

### FIELD OF THE INVENTION

The present invention relates to a drivetrain of a wind turbine, comprising a low speed interface configured to be connected to a rotor of the wind turbine, a generator having a generator output, and a lubrication system arranged relative to the low speed interface or the generator. The lubrication system is configured to circulate a lubrication medium through at least the low speed interface or generator via a pipe system. The lubrication system comprises at least a pump unit, a main filter system, a heat exchanger unit and a distribution unit.

The present invention further relates to a wind turbine comprising the lubrication system.

### BACKGROUND OF THE INVENTION

It is known that debris contamination in lubrication oil for wind turbine gearboxes can lead to severe and progressive damage or failure of the gearbox components. Therefore, the lubrication oil from the gearbox is circulated through a filtration system before being distributed back into the gearbox. The filtration system is configured for the removal of the debris and other unwanted particles from the lubrication oil.

WO 2010/052271 A1 discloses a lubrication system for a wind turbine, where lubrication oil is pumped out of the gearbox, through a filter and a heat exchanger before entering the gearbox. The heat exchanger is arranged upstream relative to the filter, where a variable flow valve may be used to bypass the heat exchanger. However, any debris or other particles from the heat exchanger or bypass valve is led directly back into the gearbox.

EP 3574212 B1 discloses a drivetrain of a wind turbine, where a lubrication system is arranged relative to the drivetrain. During operation, the lubrication oil is pumped by two main pumps through return pipes to two filters and further to a heat exchanger. From the heat exchanger, the lubrication oil is led to a manifold distribution unit before being led into the drivetrain again. However, any debris or other particles from the heat exchanger is led directly back into the gearbox.

EP 2756189 B1 discloses a lubrication system for a gearbox of a wind turbine, where a pump lubrication oil from the gearbox outlet to a filter arrangement and further through an oil cooler before the lubrication oil enters the gearbox inlet. The filter arrangement comprises a fine inlet filter and other filters interconnected in parallel to control the pressure drop. However, this solution requires a balance between the smoothness of the gears and the lubrication oil viscosity.

CN 217736231 U discloses a lubrication system for a gearbox of a wind turbine, where a mechanical pump and an electrical pump are arranged in parallel to pump the lubrication oil from the gearbox to the filter system and through the air cooler. From the air cooler, the lubrication oil is led back into the gearbox via a distribution valve block. The filter system comprises a fine filter and a coarse filter. However, any debris or other particles from the air cooler is led directly back into the gearbox.

Other lubrication systems for wind turbine gearboxes, such as disclosed in US 2013/00288843 A1, comprise an oil tank connected to the gearbox via a lubrication circuit. The lubrication circuit comprises a pump and a filter system arranged downstream of the pump, where lubrication oil is pumped from the tank, through the filter system and into the respective sections of the gearbox. Heat exchangers in the lubrication circuit are used to control the viscosity and temperature of the lubrication oil being pumped into the gearbox. However, the oil tank requires regular cleaning as debris from the gearbox accumulates in the tank. Further, debris or other particles may over time be deposited in the pump or heat exchangers, thereby reducing their efficiency.

Hence, there is a need for an improved lubrication system for a drivetrain of a wind turbine.

### OBJECT OF THE INVENTION

One object of the present invention is to solve the abovementioned problems of the prior art, or at least provide an alternative solution.

Another object of the present invention is to provide a drivetrain and a wind turbine that reduces the risk of debris from the heat exchanger entering the gearbox.

A further object of the present invention is to provide a drivetrain and a wind turbine that reduces the risk of debris entering the gearbox during maintenance of the filter system.

### DESCRIPTION OF THE INVENTION

One object of the present invention is achieved by a drivetrain of a wind turbine comprising:

a low speed interface configured to be connected to a rotor of the wind turbine, to provide mechanical torque directly or indirectly to a generator having a generator output;

wherein the generator comprises a generator rotor rotatably arranged relative to a generator stator and configured to interact with the generator stator via at least one magnetic field; and

a lubrication system arranged relative to at least the low speed interface or the generator, wherein the lubrication system is configured to circulate a lubrication medium through at least the low speed interface or the generator via a pipe system, the lubrication system comprising at least one pump unit, at least one main filter system, at least one heat exchanger unit and at least one distribution unit, wherein

the lubrication system further comprises at least one secondary filter system, wherein the secondary filter system is arranged downstream relative to the heat exchanger unit.

This provides added protection of the rotating parts and bearings in the drivetrain against contamination from the lubrication system components located upstream relative to the distribution unit. The present invention provides an additional filter system between the distribution unit and the oil conditioning components. Furthermore, contaminations from the drivetrain are filtered out downstream relative to one or more of the oil conditioning components by the main filter system.

The lubrication system may comprise various oil conditioning components, such as heat exchangers, pumps and the like. The heat exchanger may use a second medium for cooling or heating the lubrication medium, where the second medium may be separated from the lubrication medium. The second medium may be a liquid, e.g., water, or a gas, e.g., air. This allows for isolated flows of the lubrication medium and second medium within the heat exchanger.

The pump may be driven by a motor connected to an energy source. The motor may be an electrical, hydraulic or pneumatic driven motor. The motor may be powered by a separate energy source, or by a mechanical or electrical power output of the drivetrain. This reduces the need for separate drive units in the wind turbine, thus reducing the costs and saving weight.

The main filter system is arranged upstream relative to the heat exchanger. Preferably, the main filter may be arranged downstream relative to a lubrication output of the low speed interface or generator and upstream relative to the pump. Alternatively, the main filter system may be arranged between the pump and the heat exchanger. This allows a main part of the contamination from the drivetrain to be filtered out as the lubrication medium exits the drivetrain components. This in turn eliminates, or at least reduces, the maintenance requirement of the secondary filter system.

Further, the secondary filter system is arranged downstream relative to the heat exchanger. Preferably, the secondary filter system may be arranged downstream relative to the heat exchanger and upstream relative to the distribution unit or a lubrication input of the low speed interface or generator. Alternatively, the secondary filter system may be arranged between components of the distribution unit, or between the distribution unit and the lubrication input. This provides a higher protection of the respective drivetrain components against contamination from the lubrication system components as the contaminations may be filtered out as the lubrication medium enters the drivetrain components. This eliminates the need for individual filters per lubrication input of each drivetrain component, thus reducing the total number of filters needed.

The distribution unit may be a common manifold connected to all the drivetrain components, or individual manifolds each connected to the lubrication inputs of a dedicated drivetrain component. The distribution unit may also comprise one or more valves configured to distribute the lubrication medium to the drivetrain components. This allows for use of a common lubrication circuit for the drivetrain components, or dedicated lubrication circuits for each drivetrain component.

Alternatively, the distribution unit may be omitted and the lubrication medium may be distributed directly to the drivetrain component via the pipe system.

Optionally, the lubrication medium for each drivetrain component may flow into and out of a common tank or chamber. This allows for the use of a shared lubrication system.

In one embodiment, the main filter system comprises at least one main filter with a first filtration rate and the secondary filter system comprises at least one secondary filter with a second filtration rate, wherein the first filtration rate is equal to the second filtration rate.

One or more main filters are arranged in parallel and/or in series within the main filter system, where the main filters together define a combined main filtration rate. Similarly, one or more secondary filters are arranged in parallel and/or in series within the secondary filter system, where the secondary filters together define a combined secondary filtration rate.

The filters of the main and secondary filter systems can be selected to form a dual filtration system. This reduces the risk of debris and other particles from the heat exchanger entering the drivetrain components.

The main filter system and the secondary filter system may in this embodiment have the same filter configuration and/or the same filtration rate. For example, the main filter system and the secondary filter system may have the same filtration rate, but different filter configurations, or vice versa. Alternatively, the main filter system and the secondary filter system may have the same filter configuration and the same filtration rate.

In one embodiment, the main filter system comprises at least one main filter with a first filtration rate and the secondary filter system comprises at least one secondary filter with a second filtration rate, wherein the first filtration rate differs from the second filtration rate.

The filters of the main and secondary filter systems can be selected to form alternate dual filtration system. This also reduces the risk of debris and other particles from the heat exchanger entering the drivetrain components.

The main filter system and the secondary filter system may in this embodiment have different filter configurations and/or different filtration rates. For example, the main filter system and the secondary filter system may have different filtration rates, but the same filter configuration. Alternatively, the main filter system and the secondary filter system may have different filtration rates and different filter configurations.

The filtration size of the respective main filters and/or the secondary filters may be selected based on the temperature range, viscosity and type of lubrication medium used and the particle sizes of the contaminations. The lubrication medium may be oil or another type of lubricant, preferably a synthetic oil or lubricant.

In one embodiment, one of the main and secondary filters is a finer filter and the other of the main and secondary filters is a coarse filter.

The type of main and secondary filters can be selected to filter out both fine and coarse debris. For example, the main filters may be configured to filter out coarse debris and the secondary filters may be configured to filter out fine debris. Alternatively, one or both of the main filter and secondary filter systems may be configured to filter out both fine and coarse debris. This increases the overall filtration range of the lubrication system, thus reducing the risk of failures in the drivetrain components and increasing the intervals for exchange of the lubrication medium.

In one embodiment, a ratio of a second filtration size of the secondary filter system to a first filtration size of the main filter system is between 2 and 50.

An optimal ratio for filtering out unwanted debris and other particles may be selected based on the drivetrain configuration and type of lubrication medium used. The main filter(s) may have a first filtration size with a predetermined efficiency. Further, the secondary filter(s) may have a second filtration size with a predetermined efficiency. The applicant has found that an optimal filtration effect may be achieved if the ratio between the second filtration size to the first filtration range is selected between 2 and 50.

In one embodiment, the first filtration size is selected within a range between 2µm and 500µm.

Preferably, the first filtration size may be selected so that a main part of the unwanted particles or debris is filtered out by the main filters. Preferably, the main filters may be selected to have a first filtration size between 2µm and 500µm. This allows most of the debris and other unwanted particles from the drivetrain components to be filtered out before the lubrication medium enters the heat exchanger.

In one embodiment, the second filtration size is selected within a range between 10µm and 2500µm.

Preferably, the second filtration size of the secondary filters may be selected to at least filter out debris and other unwanted particles that are not removed in the main filters. The heat exchanger may be long and may be fitted with small flow passages, which are prone to debris release over time caused by, for example, vibrations. Therefore, the second filtration size of the secondary filters may be further selected to filter out debris released from the heat exchanger. Thus, the secondary filters may be selected to have a second filtration size between 10µm and 2500µm.

In one embodiment, the drivetrain further comprises a gearbox with at least one gear stage, wherein the gearbox comprises a gearbox input configured to transfer torque to the at least one gear stage and a gearbox output configured to be connected to the generator rotor.

The drivetrain may further comprise a gearbox with a gearbox input configured to be connected to the rotor, e.g., a hub thereof, of the wind turbine. The gearbox further has a gearbox output configured to be connected to the generator rotor. The gearbox may be arranged between the rotor and the generator rotor. The gearbox may comprise a single gear stage or multiple gear stages. This allows the low rotational speed of the rotor to be transformed into a medium or high rotational speed for the generator.

Optionally, the gearbox may be connected directly to the rotor via the low speed interface.

In one embodiment, the low speed interface comprises a main bearing arrangement, the main bearing arrangement having a main bearing housing, a main shaft and at least one main bearing arranged between the main shaft and the main bearing housing.

The gearbox or generator rotor may be connected indirectly to the rotor via a main bearing arrangement. The main bearing arrangement may comprise a main shaft configured to be connected to the rotor at one end and to the gearbox input at the other end. At least one main bearing may be arranged relative to the main shaft for support. Preferably, a front main bearing and a rear main bearing may be arranged relative to the main shaft. The rear main bearing may be a shared bearing between the main bearing arrangement and the first stage of the gearbox.

The main bearing arrangement may further comprise a main bearing housing extending around the main shaft. The main bearing housing may be connected to a gearbox housing at the rear end. The main bearing housing may act as a seat for the main bearing(s).

In one embodiment, the drivetrain is an integrated drivetrain or a direct drive.

The present invention allows the drivetrain to be configured as an integrated drivetrain, where the generator, the gearbox and/or the main bearing arrangement are integrated to form a compact drivetrain. The lubrication system may be connected to this integrated drivetrain and configured to supply lubrication to the bearings, gear components and other rotating parts.

Further, the present invention also allows the drivetrain to be configured as a direct drive, where the gearbox and/or the main bearing arrangement are omitted and the generator rotor is connected to the rotor. The lubrication system may be connected to this direct drive and configured to supply lubrication to the bearings and other rotating parts.

One object of the present invention is achieved by a wind turbine, as mentioned in claim 11, comprising a wind turbine tower, a nacelle arranged on top of the wind turbine tower, and a rotor comprising a hub and at least one wind turbine blade, wherein the rotor is arranged relative to the nacelle and mechanically connected to a drivetrain of the wind turbine, characterised in that the drivetrain is configured as described above.

This provides a wind turbine with an improved lubrication system for the drivetrain compared to conventional lubrication systems. The present invention provides added protection of drivetrain components against contamination from all lubrication system components located upstream relative to the distribution unit. This also provides protection during main filter maintenance, which can lead to debris ingestion as debris can be introduced while the main filter cartridge is removed.

Preferably, the secondary filters may be selected to have a greater filtration size than the filtration size of the main filters. This allows most of the debris and other unwanted particles to be filtered out by the main filters, while the secondary filters may filter out debris introduced during maintenance of the main filter and heat exchanger.

### DESCRIPTION OF THE DRAWING

The present invention is described by example only and with reference to the drawings, wherein:

FIG. 1 shows an exemplary embodiment of a wind turbine,

FIG. 2 shows a first embodiment of a drivetrain of the wind turbine,

FIG. 3 shows a second embodiment of a drivetrain of the wind turbine,

FIG. 4 shows an exemplary embodiment of a main bearing arrangement, and

FIG. 5 shows an exemplary embodiment of the lubrication system according to present invention.

In the following text, the figures will be described one by one, and the different parts and positions seen in the figures will be numbered with the same numbers in the different figures. Not all parts and positions indicated in a specific figure will necessarily be discussed together with that figure.

### DETAILED DESCRIPTION OF THE INVENTION

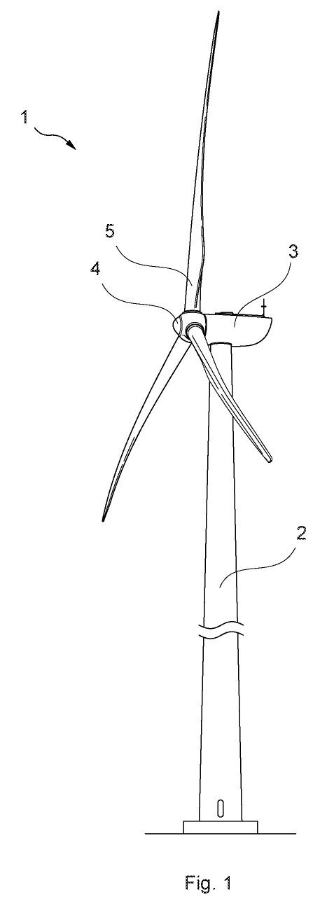

FIG. 1 shows an exemplary embodiment of a wind turbine 1 comprising a wind turbine tower 2, a nacelle 3 arranged on top of the wind turbine tower 2, and a rotor connected to a drivetrain in the nacelle 3. The rotor comprises a hub 4 and at least one wind turbine blade 5 connected to the hub 4. Here, three wind turbine blades 5 are shown, but the hub 5 may be connected to two, four or more wind turbine blades.

The wind turbine 1 is here shown as an onshore wind turbine, but the wind turbine 1 may also be an offshore wind turbine 1.

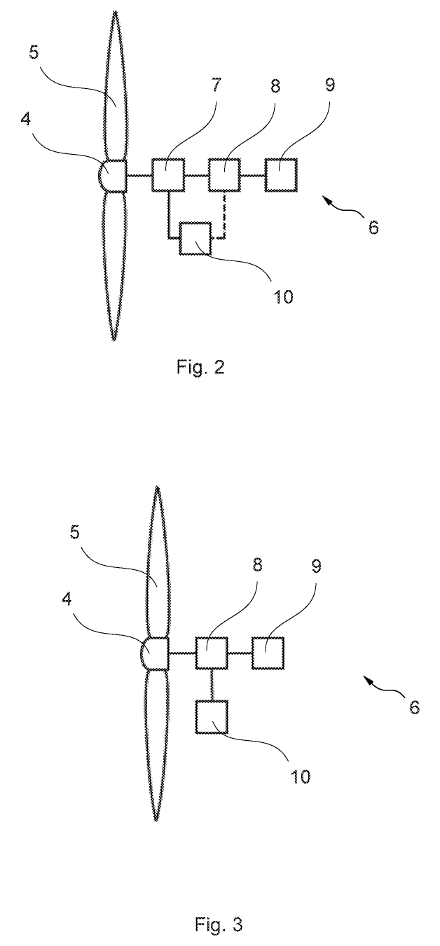

FIG. 2 shows a first exemplary embodiment of a drivetrain 6 of the wind turbine 1, where the rotor is mechanically connected to an input interface of a gearbox 7 for transferring torque to the gear stages of the gearbox 7. The hub 4 may be connected to the gearbox input via a low speed interface.

An output interface of the gearbox 7 is mechanically connected to a rotor of a generator 8. The generator 8 further comprises a generator stator arranged relative to the generator rotor, each of which comprises a plurality of pole units configured to interact with each other via at least one magnetic field. Rotation of the generator rotor relative to the generator stator generates an electrical output current in the generator 8.

The output of the generator 8 is connected to power conversion components 9, which are configured to transform the electrical power output of the generator 8 into a power output suitable for an electrical grid. Particularly, the power output may be supplied to the electrical grid via a synchronised grid connection.

FIG. 3 shows a second exemplary embodiment of the drivetrain 6 of the wind turbine 1, where the rotor is mechanically connected directly to the generator rotor for transferring torque to the generator 8. The hub 4 may be connected directly to the generator rotor via the low speed interface.

A lubrication system 10 is further connected to at least the gearbox 7, optionally also to the generator 8 as illustrated by the dotted line in FIG. 2. The lubrication system 10 is configured to circulate a lubrication medium, such as oil, through one or more components in the drivetrain 6.

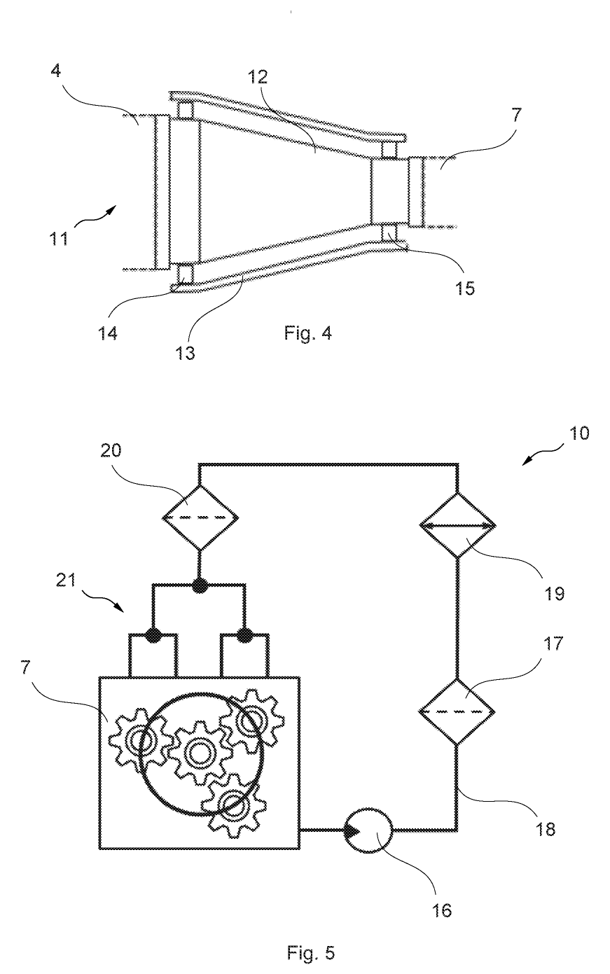

FIG. 4 shows an exemplary embodiment of a main bearing arrangement 11 arranged between the rotor hub 4 and the gearbox 7. The main bearing arrangement 11 comprises a main shaft 12 configured to be connected to the rotor hub 4 at one end and to be connected to the gearbox input at the other end. The main shaft 12 is arranged within a main bearing housing 13.

A front main bearing 14 is arranged at the front end of the main shaft 12. Further, a rear main bearing 15 is arranged at the rear end of the main shaft 12. The main bearing housing 13 acts as a seat for the front and rear main bearings 14, 15.

FIG. 5 shows an exemplary embodiment of the lubrication system 10 according to the present invention. Here, the lubrication system 10 is connected to the gearbox 7 via a pipe system 18, but can also be connected to the main bearing arrangement 11 and/or the generator 8.

The lubrication system 10 comprises a pump 16 connected to a lubrication output of the gearbox 7. The pump 16 is arranged downstream relative to a main filter system 17 with one or more main filters, which is configured to filter out debris in the lubrication medium. The main filter system 17 is further arranged upstream relative to a heat exchanger 19. The heat exchanger 19 is configured to cool or heat the lubrication medium to a desired temperature.

A distribution unit 21 is arranged upstream relative to a lubrication input of the gearbox 7. The distribution unit 21 is configured to distribute the lubrication medium to the respective components in the gearbox 7.

A secondary filter system 20 with one or more secondary filters is arranged downstream relative to the heat exchanger 19. The secondary filter system 20 is further arranged upstream relative to the distribution unit 21. The secondary filter system 20 is configured to further filter out debris in the lubrication medium.

Preferably, the ratio between the second filtration size of the secondary filters to the first filtration size of the main filters is selected between 2 to 50.

1. A drivetrain (6) for a wind turbine (1), comprising:
a low speed interface configured to be connected to a rotor of the wind turbine (1), to provide mechanical torque directly or indirectly to a generator (8) having a generator output; wherein
the generator (8) comprises a generator rotor rotatably arranged relative to a generator stator and configured to interact with the generator stator via at least one magnetic field; and
a lubrication system (10) arranged relative to at least the low speed interface or the generator (8), wherein the lubrication system (10) is configured to circulate a lubrication medium through at least the low speed interface or the generator (8) via a pipe system (18), the lubrication system (10) comprising at least one pump unit (16), at least one main filter system (17), at least one heat exchanger unit (19) and at least one distribution unit (21), wherein
the lubrication system (10) further comprises at least one secondary filter system (20), wherein the secondary filter system (20) is arranged downstream relative to the heat exchanger unit (19).

2. The drivetrain according to claim 1, wherein the main filter system (17) comprises at least one main filter with a first filtration rate and the secondary filter system (20) comprises at least one secondary filter with a second filtration rate, wherein the first filtration rate is equal to the second filtration rate.

3. The drivetrain according to claim 1, wherein the main filter system (17) comprises at least one main filter with a first filtration rate and the secondary filter system (20) comprises at least one secondary filter with a second filtration rate, wherein the first filtration rate differs from the second filtration rate.

4. The drivetrain according to claim 3, wherein one of the main and secondary filters is a finer filter and the other of the main and secondary filters is a coarse filter.

5. The drivetrain according to claim 1, wherein a ratio of a second filtration size of the secondary filter system (20) to a first filtration size of the main filter system (17) is between 2 and 50.

6. The drivetrain according to claim 1, wherein the first filtration size is selected within a range between 2µm and 500µm.

7. The drivetrain according to claim 1, wherein the second filtration size is selected within a range between 10µm and 2500µm.

8. The drivetrain according to claim 1, wherein the drivetrain further comprises a gearbox (7) with at least one gear stage, wherein the gearbox (7) comprises a gearbox input configured to transfer torque to the at least one gear stage and a gearbox output configured to be connected to the generator rotor.

9. The drivetrain according to claim 1, wherein the low speed interface comprises a main bearing arrangement (11), the main bearing arrangement having a main bearing housing (13), a main shaft (12) and at least one main bearing (14, 15) arranged between the main shaft (12) and the main bearing housing (13).

10. The drivetrain according to claim 1, wherein the drivetrain (6) is an integrated drivetrain or a direct drive.

11. A wind turbine (1) comprising a wind turbine tower (2), a nacelle (3) arranged on top of the wind turbine tower (2), and a rotor comprising a hub (4) and at least one wind turbine blade (5), wherein the rotor is arranged relative to the nacelle (3) and mechanically connected to a drivetrain (6) of the wind turbine (1), wherein the drivetrain (6) of the wind turbine (1) comprises:
a low speed interface configured to be connected to a rotor of the wind turbine (1), to provide mechanical torque directly or indirectly to a generator (8) having a generator output; wherein
the generator (8) comprises a generator rotor rotatably arranged relative to a generator stator and configured to interact with the generator stator via at least one magnetic field; and
a lubrication system (10) arranged relative to at least the low speed interface or the generator (8), wherein the lubrication system (10) is configured to circulate a lubrication medium through at least the low speed interface or the generator (8) via a pipe system (18), the lubrication system (10) comprising at least one pump unit (16), at least one main filter system (17), at least one heat exchanger unit (19) and at least one distribution unit (21), wherein
the lubrication system (10) further comprises at least one secondary filter system (20), wherein the secondary filter system (20) is arranged downstream relative to the heat exchanger unit (19).
